(19) United States
(12) Patent Application Publication
(10) Pub. No.: US 2014/0317730 A1
(43) Pub. Date: Oct. 23, 2014

(54) Providing a Domain to IP Address Reputation Service

(71) Applicant: INTERNATIONAL BUSINESS MACHINES CORPORATION, Armonk, NY (US)

(72) Inventors: Paul A. Ashley, Toowong (AU); Carsten Hagemann, Southport (AU)

(73) Assignee: International Business Machines Corporation, Armonk, NY (US)

(21) Appl. No.: 13/864,743

(22) Filed: Apr. 17, 2013

(51) Int. Cl. H04L 29/06

(52) U.S. Cl. CPC H04L 63/12
USPC 726/22

(57) ABSTRACT

An approach is provided to verify a network address. In the approach, a network address is received from a domain name service (DNS) based on a requested uniform resource locator (URL) that corresponds to a requested domain. A set of one or more network addresses previously established as corresponding to the requested domain is retrieved from a data store accessible from the information handling system. The information handling system is automatically connected to the network address in response to the received network address matching one of the set of one or more retrieved network addresses.

### TECHNICAL FIELD

The present disclosure relates to an approach that provides reputation input used in network address translations in order to reduce malevolent network intrusions.

### BACKGROUND OF THE INVENTION

When a user starts an encrypted connection to a website, the user is traditionally asked to trust two independent sources. First, the user places trust in the Certification Authority (CA), which signs the certificate of the website as being genuine. Second, the user places trust in the Internet protocol (IP) address obtained from the Domain Name System (DNS) that translates the domain name to the IP address and verifies that the IP address belongs to the website to which the user wishes to connect. The problem is that both of these sources can be compromised. Past attacks against Certification Authorities have shown that it is possible to steal a certificate, which is valid for a domain name, and which does not belong to the owner of the certificate. Ownership of a certificate alone is useless to the attacker until he is able to send the user to an alternate website that is controlled by the attacker. To reroute the user's request, the attacker manipulates the DNS response. Various methods of manipulating DNS responses include (1) DNS cache poisoning, (2) direct manipulation of the DNS records, and (3) manipulation of the local DNS storage on client side. In such an attack scenario, a user requests a website by entering a domain name. The user gets a fake DNS response and is consequently redirect to a different server that is controlled by the attacker. Since the fake server has a valid certificate, no attack indication is provided to the user. The user may then unwittingly provide sensitive or confidential information, such as bank account numbers, passwords, etc. since the user does not realize he is being attacked.

### SUMMARY

An approach is provided to verify a network address. In the approach, a network address is received from a domain name service (DNS) based on a requested uniform resource locator (URL) that corresponds to a requested domain. A set of one or more network addresses previously established as corresponding to the requested domain is retrieved from a data store accessible from the information handling system. The information handling system is automatically connected to the network address in response to the received network address matching one of the set of one or more retrieved network addresses.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present invention, as defined solely by the claims, will become apparent in the non-limiting detailed description set forth below.

### BRIEF DESCRIPTION OF THE DRAWINGS

The present invention may be better understood, and its numerous objects, features, and advantages made apparent to those skilled in the art by referencing the accompanying drawings, wherein:

FIG. 1 is a block diagram of a data processing system in which the methods described herein can be implemented;

FIG. 2 provides an extension of the information handling system environment shown in FIG. 1 to illustrate that the methods described herein can be performed on a wide variety of information handling systems which operate in a networked environment;

FIG. 3 is a component diagram showing the various components used in one embodiment of an approach that provides reputation input used in network address translations in order to reduce malevolent network intrusions;

FIG. 4 is a component diagram showing the various components used in a single-system implementation of the approach that provides reputation input in order to reduce malevolent network intrusions;

FIG. 5 is a component diagram showing the various components used in an enterprise implementation of the approach that provides reputation input in order to reduce malevolent network intrusions;

FIG. 6 is a depiction of a flowchart showing the logic used to provide reputation input to a user in order to reduce malevolent network intrusions; and

FIG. 7 is a depiction of a flowchart showing the logic performed to update stored domain and IP address data used to reduce malevolent network intrusions.

### DETAILED DESCRIPTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer, server, or cluster of servers. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

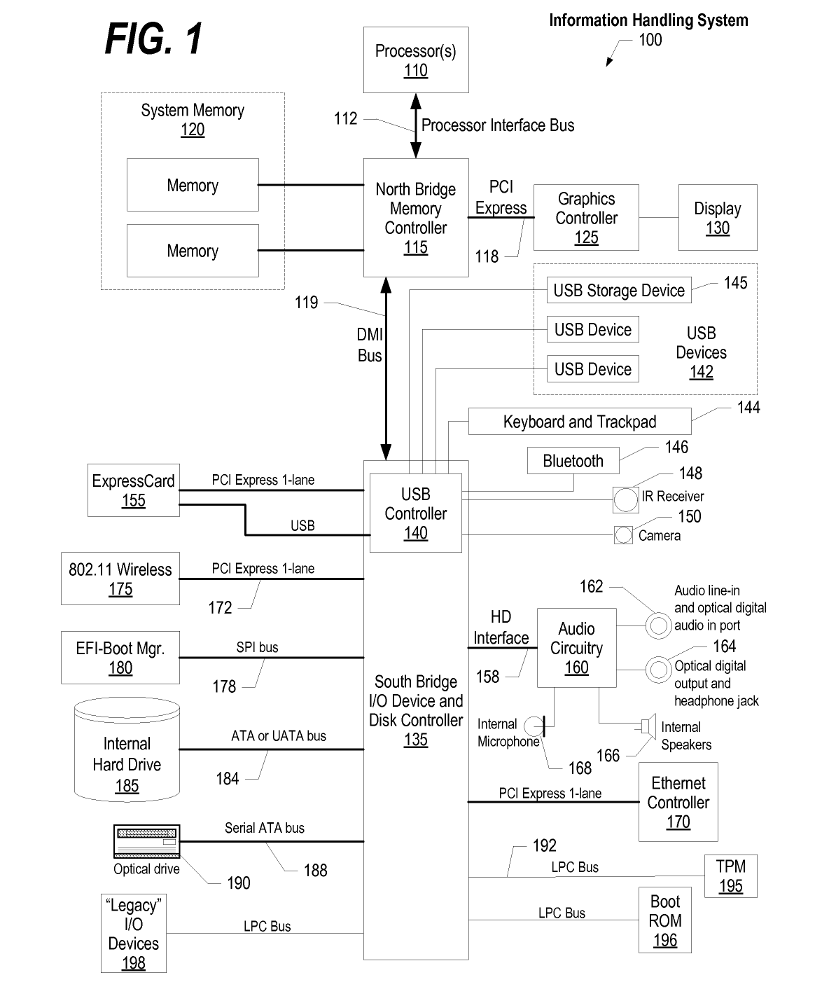

FIG. 1 illustrates information handling system 100, which is a simplified example of a computer system capable of performing the computing operations described herein. Information handling system 100 includes one or more processors 110 coupled to processor interface bus 112. Processor interface bus 112 connects processors 110 to Northbridge 115, which is also known as the Memory Controller Hub (MCH). Northbridge 115 connects to system memory 120 and provides a means for processor(s) 110 to access the system memory. Graphics controller 125 also connects to Northbridge 115. In one embodiment, PCI Express bus 118 connects Northbridge 115 to graphics controller 125. Graphics controller 125 connects to display device 130, such as a computer monitor.

Northbridge 115 and Southbridge 135 connect to each other using bus 119. In one embodiment, the bus is a Direct Media Interface (DMI) bus that transfers data at high speeds in each direction between Northbridge 115 and Southbridge 135. In another embodiment, a Peripheral Component Interconnect (PCI) bus connects the Northbridge and the Southbridge. Southbridge 135, also known as the I/O Controller Hub (ICH) is a chip that generally implements capabilities that operate at slower speeds than the capabilities provided by the Northbridge. Southbridge 135 typically provides various busses used to connect various components. These busses include, for example, PCI and PCI Express busses, an ISA bus, a System Management Bus (SMBus or SMB), and/or a Low Pin Count (LPC) bus. The LPC bus often connects low-bandwidth devices, such as boot ROM 196 and “legacy” I/O devices (using a “super I/O” chip). The “legacy” I/O devices (198) can include, for example, serial and parallel ports, keyboard, mouse, and/or a floppy disk controller. The LPC bus also connects Southbridge 135 to Trusted Platform Module (TPM) 195. Other components often included in Southbridge 135 include a Direct Memory Access (DMA) controller, a Programmable Interrupt Controller (PIC), and a storage device controller, which connects Southbridge 135 to nonvolatile storage device 185, such as a hard disk drive, using bus 184.

ExpressCard 155 is a slot that connects hot-pluggable devices to the information handling system. ExpressCard 155 supports both PCI Express and USB connectivity as it connects to Southbridge 135 using both the Universal Serial Bus (USB) the PCI Express bus. Southbridge 135 includes USB Controller 140 that provides USB connectivity to devices that connect to the USB. These devices include webcam (camera) 150, infrared (IR) receiver 148, keyboard and trackpad 144, and Bluetooth device 146, which provides for wireless personal area networks (PANs). USB Controller 140 also provides USB connectivity to other miscellaneous USB connected devices 142, such as a mouse, removable nonvolatile storage device 145, modems, network cards, ISDN connectors, fax, printers, USB hubs, and many other types of USB connected devices. While removable nonvolatile storage device 145 is shown as a USB-connected device, removable nonvolatile storage device 145 could be connected using a different interface, such as a Firewire interface, etcetera.

Wireless Local Area Network (LAN) device 175 connects to Southbridge 135 via the PCI or PCI Express bus 172. LAN device 175 typically implements one of the IEEE 0.802.11 standards of over-the-air modulation techniques that all use the same protocol to wireless communicate between information handling system 100 and another computer system or device. Optical storage device 190 connects to Southbridge 135 using Serial ATA (SATA) bus 188. Serial ATA adapters and devices communicate over a high-speed serial link. The Serial ATA bus also connects Southbridge 135 to other forms of storage devices, such as hard disk drives. Audio circuitry 160, such as a sound card, connects to Southbridge 135 via bus 158. Audio circuitry 160 also provides functionality such as audio line-in and optical digital audio in port 162, optical digital output and headphone jack 164, internal speakers 166, and internal microphone 168. Ethernet controller 170 connects to Southbridge 135 using a bus, such as the PCI or PCI Express bus. Ethernet controller 170 connects information handling system 100 to a computer network, such as a Local Area Network (LAN), the Internet, and other public and private computer networks.

While FIG. 1 shows one information handling system, an information handling system may take many forms. For example, an information handling system may take the form of a desktop, server, portable, laptop, notebook, or other form factor computer or data processing system. In addition, an information handling system may take other form factors such as a personal digital assistant (PDA), a gaming device, ATM machine, a portable telephone device, a communication device or other devices that include a processor and memory.

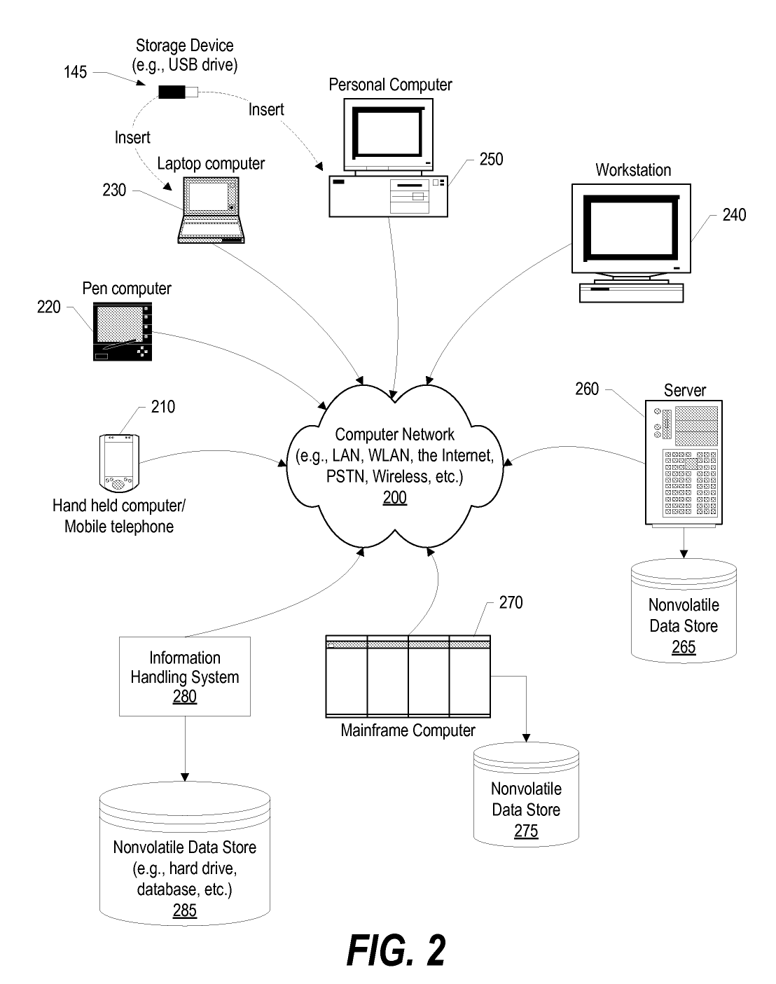

The Trusted Platform Module (TPM 195) shown in FIG. 1 and described herein to provide security functions is but one example of a hardware security module (HSM). Therefore, the TPM described and claimed herein includes any type of HSM including, but not limited to, hardware security devices that conform to the Trusted Computing Groups (TCG) standard, and entitled “Trusted Platform Module (TPM) Specification Version 1.2.” The TPM is a hardware security subsystem that may be incorporated into any number of information handling systems, such as those outlined in FIG. 2.

FIG. 2 provides an extension of the information handling system environment shown in FIG. 1 to illustrate that the methods described herein can be performed on a wide variety of information handling systems that operate in a networked environment. Types of information handling systems range from small handheld devices, such as handheld computer/mobile telephone 210 to large mainframe systems, such as mainframe computer 270. Examples of handheld computer 210 include personal digital assistants (PDAs), personal entertainment devices, such as MP3 players, portable televisions, and compact disc players. Other examples of information handling systems include pen, or tablet, computer 220, laptop, or notebook, computer 230, workstation 240, personal computer system 250, and server 260. Other types of information handling systems that are not individually shown in FIG. 2 are represented by information handling system 280. As shown, the various information handling systems can be networked together using computer network 200. Types of computer network that can be used to interconnect the various information handling systems include Local Area Networks (LANs), Wireless Local Area Networks (WLANs), the Internet, the Public Switched Telephone Network (PSTN), other wireless networks, and any other network topology that can be used to interconnect the information handling systems. Many of the information handling systems include nonvolatile data stores, such as hard drives and/or nonvolatile memory. Some of the information handling systems shown in FIG. 2 depicts separate nonvolatile data stores (server 260 utilizes nonvolatile data store 265, mainframe computer 270 utilizes nonvolatile data store 275, and information handling system 280 utilizes nonvolatile data store 285). The nonvolatile data store can be a component that is external to the various information handling systems or can be internal to one of the information handling systems. In addition, removable nonvolatile storage device 145 can be shared among two or more information handling systems using various techniques, such as connecting the removable nonvolatile storage device 145 to a USB port or other connector of the information handling systems.

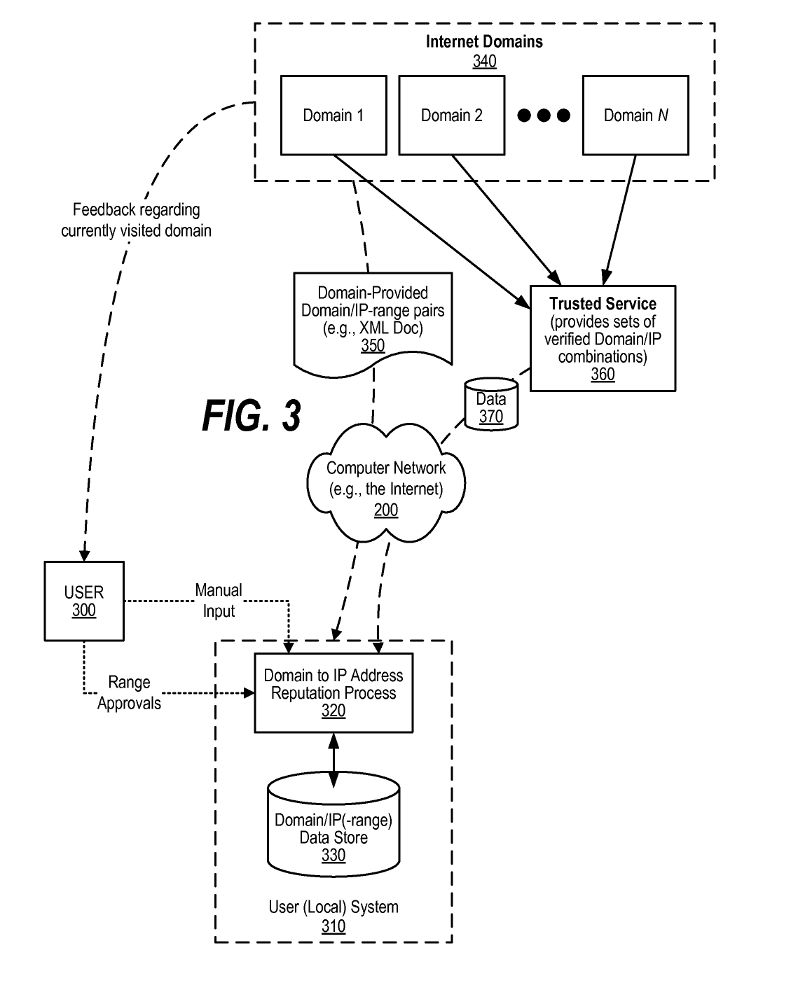

FIGS. 3-7 depict an approach that can be executed on an information handling system, such as a mobile device, and computer network as shown in FIGS. 1-2. The core idea of this approach is to use reputation data to assist a user in preventing malevolent network-based attacks. The approach verifies the IP Address of the requested Domain on the client side. The approach performs the verification by checking data stored in the client's local storage. These checks include (1) checking if the IP address is contained in a stored list of valid IP ranges for the particular Domain, and (2) checking if the Domain/IP pair is valid. In one embodiment, the second check might be possible because of an earlier request made by the user. If one of the checks does not match, the user is notified of a potential problem. Responsively, the user can either deny the connection request or he can approve it. If the user approves the connection request, the combination of Domain and IP are added to the client's local storage. Various techniques are disclosed to supply the list of IP ranges and domains. Any one of the techniques, or a combination thereof, are used to supply the list. First, the IP address ranges can be manually supplied by the user. Second, the Domain owner can provide a file, such as an XML file, that includes the IP address ranges used by the Domain. Third, a trusted service provider, such as the IBM X-Force, can supplies the IP address ranges used by multiple Domains. This approach verifies that the IP address that the user's device is about to connect to belongs to the Domain name that was requested by the user. Further details and examples depicting various embodiments of the approach that uses reputation data to assist a user in preventing network-based attacks are shown in FIGS. 3-7, descriptions of which are found below.

FIG. 3 is a component diagram showing the various components used in one embodiment of an approach that provides reputation input used in network address translations in order to reduce malevolent network intrusions. User 300 is a user of local system 310. Local system is an information handling system as shown in FIG. 1. Examples of various types of information handling systems are shown in FIG. 2 with such information handling system being connected to computer network 200, such as the Internet.

Process 320 runs at the user's local system to provide a domain to Internet Protocol (IP) address reputation service. When the user requests a uniform resource locator (URL), such as at a browser by manual entry or by selecting a link displayed in the browser, the local system receives, from a domain name service (DNS), a network address that is based on the requested URL that corresponds to a requested domain. Process 320 retrieves, from data store 330 which is accessible from the local system, a set of one or more network addresses previously established as corresponding to the requested domain. If the requested domain corresponds to one of the network addresses retrieved from data store 330, then the local system is automatically connected to the network address. On the other hand, if the requested domain fails to match one of the retrieved network addresses, then the user of local system 310 is prompted for a trust reply. If the trust reply received from the user indicates that the user does not trust the received network address as corresponding to the requested domain, then the system does not connect the local system to the network address received from the DNS. On the other hand, if the user's trust reply indicates that the user trusts that the received network address corresponds to the requested domain, then the received network address and the requested domain are added to data store 330 and the local system is connected to the network address.

FIG. 3 further depicts techniques used to update data store 330. In one embodiment, data store 330 is updated using a list of network addresses from one of the domains shown in network domains collection 340. In this approach, a list of one or more network addresses pertaining to the domain are received in list 350, such as an Extensible Markup Language (XML) file that is prepared by the domain and distributed. The user validates the domain-provided list of network addresses using traditional validation techniques such as using private/public keys, etc. The list of network addresses may indicate ranges of network addresses that correspond to the domain. Once validated, the list is used to update and populate data store 330. In another embodiment, trusted service 360 provides data file 370 that includes a number of domains with each of the domains corresponding to any number of network addresses. Again, the user's local system validates data file 370 using traditional validation techniques and the list of network addresses may include domain-address range pairs where each of the domains can correspond to a range of network addresses. Once validated, the domain-address range pairs included in data file 370 are used to update and populate data store 330.

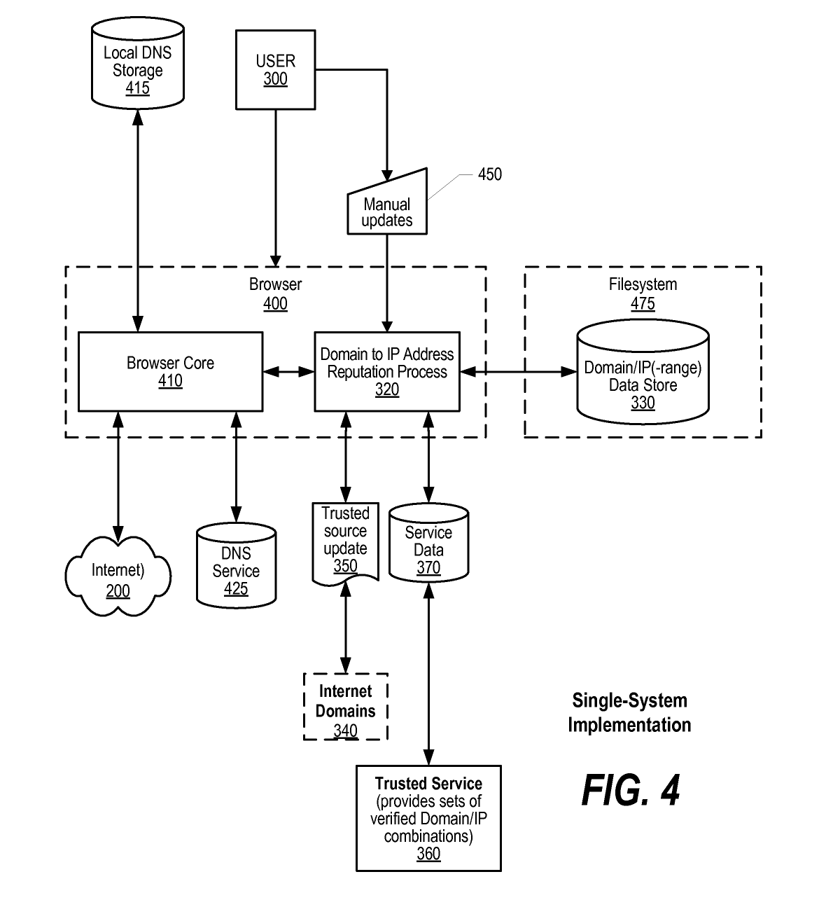

FIG. 4 is a component diagram showing the various components used in a single-system implementation of the approach that provides reputation input in order to reduce malevolent network intrusions. In the single-use implementation, process 320 that provides the domain to IP address reputation service is accessible from browser core 410 within browser application 400. For example, process 320 might be installed as a plug-in to browser application 400. Local domain name service (DNS) storage 415 is stored on a nonvolatile storage device accessible from browser core 410. User 300 utilizes browser 400 and can also submit manual updates 450 which are processed by domain to IP address reputation process 320. Browser core 410 accesses network resources via computer network 200, such as the Internet. In addition, a network-based DNS service 425 is accessed by browser core 410 in order to identify network addresses (IP addresses) based on a network name, such as a Uniform Resource Locator (URL).

Process 320 retrieves, from data store 330 which is accessible from local filesystem 475, a set of one or more network addresses previously established as corresponding to the requested domain. Data store 330 is updated using manual updates 450 provided by user 300 as well as by trusted source updates list 350, such as an Extensible Markup Language (XML) file that is prepared by Internet domains 340 and distributed via the network. Trusted service 360 provides data file 370 that includes a number of domains with each of the domains corresponding to any number of network addresses. Both list 350 and data file 370 are received at process 320. The domains and address ranges included in list 350 and data file 370 are, upon successful validation, used to update and populate data store 330.

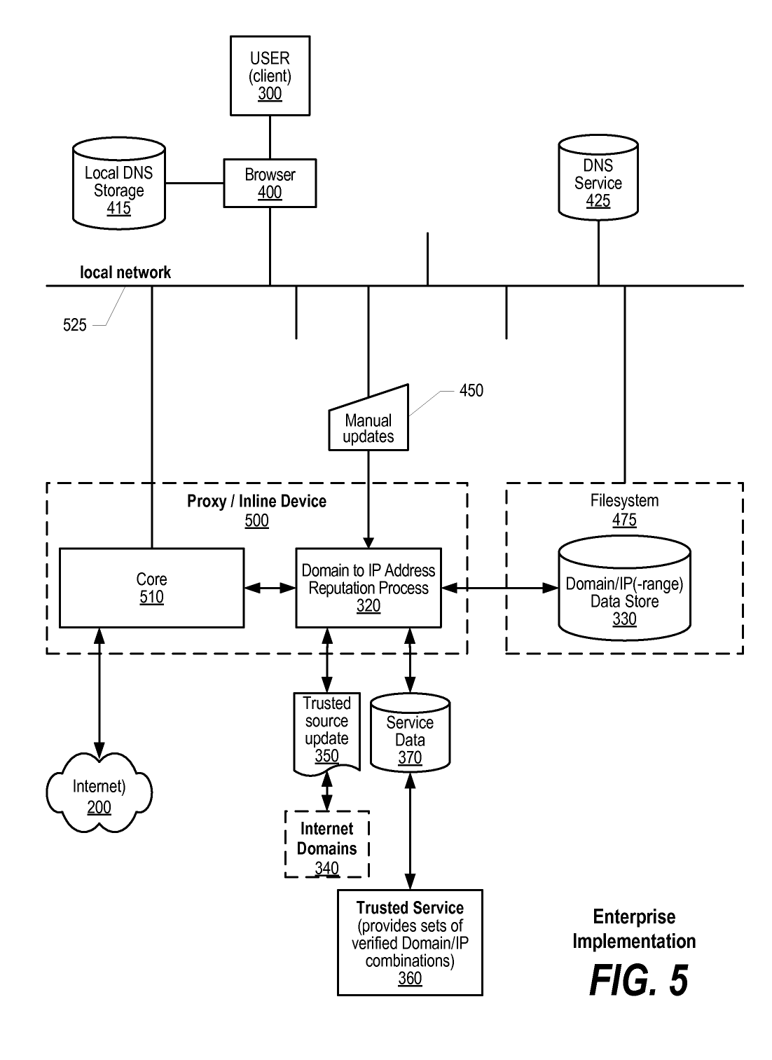

FIG. 5 is a component diagram showing the various components used in an enterprise implementation of the approach that provides reputation input in order to reduce malevolent network intrusions. Here, user 300 utilizes browser 400 which has local DNS storage accessible. In addition, DNS service 425 is available via local network 525. Proxy/inline device 500 is accessible by user 300's device via local area network 525. Proxy/inline device 500 includes core 510 and process 320. In the enterprise implementation, process 320 that provides the domain to IP address reputation service is accessible from core 510 within proxy/inline device 500.

Process 320 retrieves, from data store 330 which is stored in filesystem 475 which is accessible via local area network 525, a set of one or more network addresses previously established as corresponding to the requested domain. Data store 330 is updated using manual updates 450 provided by user 300 as well as by trusted source updates list 350, such as an Extensible Markup Language (XML) file that is prepared by Internet domains 340 and distributed via the network. Manual updates from user 300 should be first verified by an administrator before the data is usable by others. The data input from user 300 could be stored in a temporary area and moved to a production area after verification. Trusted service 360 provides data file 370 that includes a number of domains with each of the domains corresponding to any number of network addresses. Both list 350 and data file 370 are received at process 320. The domains and address ranges included in list 350 and data file 370 are, upon successful validation, used to update and populate data store 330.

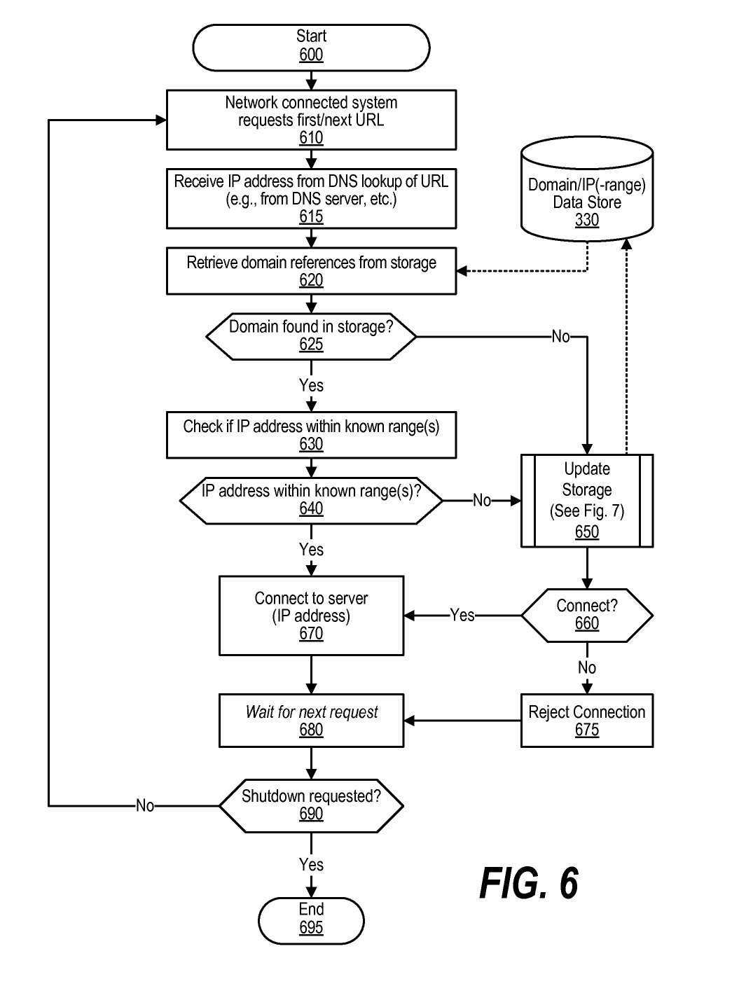

FIG. 6 is a depiction of a flowchart showing the logic used to provide reputation input to a user in order to reduce malevolent network intrusions. Processing commences at 600 whereupon, at step 610, the process receives a URL (uniform resource locator) request from a network connected system. At step 615, the process receives the network address (IP address) by performing a lookup of the URL, such as from a local or network-based domain name service (DNS) provider. At step 620, the process receives the domain references from data store 330 that correspond to the requested domain.

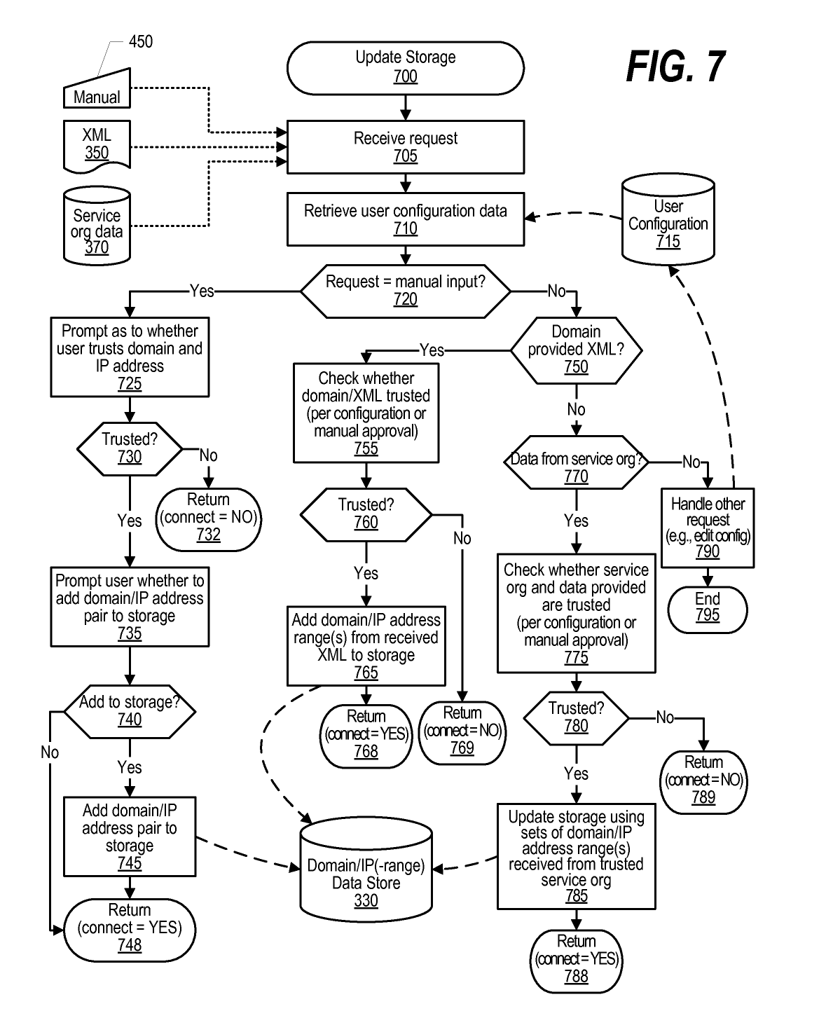

A decision is made as to whether the requested domain was found in data store 330 (decision 625). If the requested domain was found in data store 330, then decision 625 branches to the “yes” branch whereupon, at step 630, the process checks whether the network address returned by the DNS provider is within known network addresses for this domain as stored in data store 330. A decision is made as to whether the network address returned by the DNS is within the set(s) of network address ranges stored in data store 330 (decision 640). If the requested domain was not found in data store 330 (with decision 625 branching to the “no” branch) or if the network address returned by the DNS does not fall within known address ranges for this domain (with decision 640 branching to the “no” branch), then, at predefined process 650, the process executes the update storage routine to possibly update data store 330 with new information (see FIG. 7 and corresponding text for processing details). Based on the execution of predefined process 650, a decision is made as to whether the user wishes to connect to the network address provided by the DNS (decision 660). If the user wishes to connect to the network address provided by the DNS, then decision 660 branches to the “yes” branch whereupon, at step 670, the user's device connects to the network address provided by the DNS. On the other hand, if the user does not wish to connect to the network address provided by the DNS, then decision 660 branches to the “no” branch whereupon, at step 675, the connection is rejected and the user's device is not connected to the network address provided by the DNS.

Returning to decision 640, if the domain is a known domain (stored in data store 330) and the network address returned by the DNS is within the sets, or ranges, of network addresses known for this domain, then decision 640 branches to the “yes” branch whereupon, at step 670, the user's device connects to the network address provided by the DNS.

After the connection request has been processed, at step 680 the process waits for the next network connection request. A decision is made as to whether a shutdown of the process has been requested (decision 690). If a shutdown of the process has not been requested, then decision 690 branches to the “no” branch which loops back to receive the next URL requested by the user and the URL is processed as described above. This looping continues until the user wishes to shutdown the system and/or the process, at which point decision 690 branches to the “yes” branch and processing ends at 695.

FIG. 7 is a depiction of a flowchart showing the logic performed to update stored domain and IP address data used to reduce malevolent network intrusions. This routine is called by the processing shown in FIG. 6 (see predefined process 650) and is also called when list 350 is received from a domain and when data file 370 is received from a trusted service. FIG. 7 processing commences at 700 whereupon, at step 705, a request is received. As shown, requests can include manual update requests, such as when an network address is not found in data store 320 and the process seeks user approval to add the network address, a list of one or more network addresses 350 pertaining to a domain that are received from a domain, and data file 370 received from a trusted service that includes a number of domains with each of the domains corresponding to any number of network addresses. At step 710, the process receives user configuration data from data store 715. For example, user configuration data may indicate which domains can supply lists of network addresses as well as which service organizations are trusted services organizations that can provide data files to update data store 320.

A decision is made as to whether the request is a manual input request (decision 720). If the request is a manual input request, then decision 720 branches to the “yes” branch whereupon, at step 725, the process prompts the user as to whether the user trusts that the network address returned by the DNS corresponds to the domain. A decision is made, based on the user's response to the prompt, as to whether the user trusts that the network address returned by the DNS corresponds to the domain (decision 730). If the user does not trust that the network address returned by the DNS corresponds to the domain, then decision 730 branches to the “no” branch whereupon processing returns to the calling routine at 732 without updating data store 320 and with a return code indicating that the process should not connect to the network address. This decision, not to trust the data, could be cached for a period of time, so that the user does not have to be prompted again. On the other hand, if the user trusts that the network address returned by the DNS corresponds to the domain, then decision 730 branches to the “yes” branch whereupon, at step 735, the user is prompted as to whether the user wishes to update data store 320 with the domain-network address pair. A decision is made, based on the user's response, as to whether the user wishes to add the domain-network address pair to data store 320 (decision 740). If the user wishes to add the domain-network address pair to storage, then decision 740 branches to the “yes” branch whereupon, at step 745, the domain-network address pair is written to data store 320 and processing returns to the calling routine (see FIG. 6) with a return code indicating that the process should connect to the network address received from the DNS. Returning to decision 740, if the user did not wish to add the domain-network address pair to data store 320, then decision 740 branches to the “no” branch bypassing step 745 and processing returns to the calling routine (see FIG. 6) with a return code indicating that the process should connect to the network address received from the DNS.

Returning to decision 720, if the request is not a manual input request, then decision 720 branches to the “no” branch whereupon a decision is made as to whether the request is a request received by a domain to add a list of network addresses provided by a particular domain (decision 750). If the request is a request received by a domain to add a list of network addresses provided by a particular domain, then decision 750 branches to the “yes” branch whereupon, at step 755, the process checks whether the domain and/or the list (e.g., an XML file, etc.) are trusted by the user, such as per a previously set configuration setting (e.g., using public/private keys, etc.) or based upon a manual approval. A decision is made, based on the check performed at step 755, as to whether the domain and/or received list is trusted (decision 760). If the domain and the received list of network addresses are trusted, then decision 760 branches to the “yes” branch whereupon, at step 765, the process adds the received domain/network address range(s) (sets of network addresses) to data store 320 and processing returns at 768 to the calling routine indicating that the process can connect to any of the network addresses added by the domain. On the other hand, if either the domain or the received list of network addresses are not trusted, then decision 760 branches to the “no” branch whereupon the network addresses are not added to data store 320 and processing returns at 769 to the calling routine indicating that the process should not connect to any of the network addresses included in the list.

Returning to decision 750, if the request is not a request received by a domain to add a list of network addresses provided by a particular domain then decision 750 branches to the “no” branch whereupon a decision is made as to whether the request is a data file received by a service organization to add sets of domain names and network addresses to data store 320 (decision 770). If the request is a data file received by a service organization to add sets of domain names and network addresses to data store 320, then decision 770 branches to the “yes” branch whereupon, at step 775, the process checks whether the service organization and data file provided by the service organization are trusted, such as per a previously set configuration setting (e.g., using public/private keys, etc.) or based upon a manual approval. At decision 780 a determination is made as to whether the service organization is a trusted service organization and whether the data file received from the service organization is also trusted (e.g., not tampered, etc.). If the service organization and data file are trusted, then decision 780 branches to the “yes” branch whereupon, at step 785, the process updates data store 320 using sets of domain names and network address range(s) (sets) received from the trusted service organization and processing returns at 788 to the calling routine indicating that the process can connect to any of the network addresses added by the trusted service organization. On the other hand, if either the trusted service organization or the data file received by the service organization are not trusted, then decision 780 branches to the “no” branch whereupon the network addresses are not added to data store 320 and processing returns at 789 to the calling routine indicating that the process should not connect to the network addresses included in the data file.

Returning to decision 770, if the request is not a data file received by a service organization to add sets of domain names and network addresses to data store 320, then decision 770 branches to the “no” branch whereupon, at step 790, the process handles other types of requests, such as a user configuration request that updates user configuration data store 715. Processing thereafter ends at 795.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While particular embodiments of the present invention have been shown and described, it will be obvious to those skilled in the art that, based upon the teachings herein, that changes and modifications may be made without departing from this invention and its broader aspects. Therefore, the appended claims are to encompass within their scope all such changes and modifications as are within the true spirit and scope of this invention. Furthermore, it is to be understood that the invention is solely defined by the appended claims. It will be understood by those with skill in the art that if a specific number of an introduced claim element is intended, such intent will be explicitly recited in the claim, and in the absence of such recitation no such limitation is present. For non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to inventions containing only one such element, even when the same claim includes the introductory phrases “one or more” or “at least one” and indefinite articles such as “a” or “an”; the same holds true for the use in the claims of definite articles.

What is claimed is:

1. A method implemented by an information handling system to verify a network address, the method comprising:
receiving, from a domain name service (DNS) a network address based on a requested uniform resource locator (URL) that corresponds to a requested domain;
retrieving, from a data store accessible from the information handling system, a set of one or more network addresses previously established as corresponding to the requested domain; and
automatically connecting the information handling system to the network address in response to the received network address matching one of the set of one or more retrieved network addresses.

2. The method of claim 1 further comprising:
prompting a user of the information handling system for a trust reply in response to the received network address failing to match one of the set of one or more retrieved network addresses;
receiving the trust reply from the user;
refraining from connecting the information handling system to the network address in response to the trust reply failing to indicate that the user trusts the received network address as corresponding to the requested domain; and
in response to the trust reply indicating that the user trusts the received network address as corresponding to the requested domain:
adding the received network address and the requested domain to the data store; and
connecting the information handling system to the network address.

3. The method of claim 2 further comprising:
updating the data store, wherein the updating further comprises:
receiving, from a domain, a list of one or more network addresses pertaining to the domain;
validating the list; and
in response to successful validation, adding the list of one or more network addresses to the data store, wherein the added network addresses are associated with the domain.

4. The method of claim 2 further comprising:
updating the data store, wherein the updating further comprises:
receiving, from service organization, a data file that includes a plurality of domains and a plurality of network addresses, wherein each of the domains correspond to one or more of the plurality of network addresses;
validating the data file; and
in response to successful validation, adding the plurality of domains to the data store, wherein the added domains are each associated with the one or more corresponding network addresses included in the data file.

5. The method of claim 2 further comprising:
receiving a domain from the user;
receiving one or more network addresses corresponding to the received domain from the user;
adding the list of one or more network addresses to the data store, wherein the added network addresses are associated with the received domain.

6. The method of claim 2 wherein the network address is received at a browser application running on the information handling system, wherein the browser application includes a reputation process that performs the receiving, retrieving, and connecting steps, and wherein the data store is stored on a nonvolatile storage device accessible to the information handling system.

7. The method of claim 2 wherein the network address is received at a reputation process that performs the receiving, retrieving, and connecting steps on a proxy device accessible to a browser application via a local area network, and wherein the data store is stored on a nonvolatile network addressable storage device accessible to the information handling system via the local area network.

8. An information handling system comprising:
one or more processors;
a memory coupled to at least one of the processors;
a nonvolatile storage device;
a network adapter; and
a set of instructions stored in the memory and executed by at least one of the processors, wherein the set of instructions perform actions of:
receiving, via the network adapter, a network address based on a requested uniform resource locator (URL) that corresponds to a requested domain, the network address being received from a domain name service (DNS);
retrieving, from a data store stored in the nonvolatile storage device, a set of one or more network addresses previously established as corresponding to the requested domain; and
automatically connecting to the network address using the network adapter in response to the received network address matching one of the set of one or more retrieved network addresses.

9. The information handling system of claim 8 wherein the actions performed further comprise:
prompting a user of the information handling system for a trust reply in response to the received network address failing to match one of the set of one or more retrieved network addresses;
receiving the trust reply from the user;
refraining from connecting the information handling system to the network address in response to the trust reply failing to indicate that the user trusts the received network address as corresponding to the requested domain; and
in response to the trust reply indicating that the user trusts the received network address as corresponding to the requested domain:
adding the received network address and the requested domain to the data store; and
connecting the information handling system to the network address.

10. The information handling system of claim 9 wherein the actions performed further comprise:
updating the data store, wherein the updating further comprises:
receiving, from a domain, a list of one or more network addresses pertaining to the domain;
validating the list; and
in response to successful validation, adding the list of one or more network addresses to the data store, wherein the added network addresses are associated with the domain.

11. The information handling system of claim 9 wherein the actions performed further comprise:
updating the data store, wherein the updating further comprises:
receiving, from service organization, a data file that includes a plurality of domains and a plurality of network addresses, wherein each of the domains correspond to one or more of the plurality of network addresses;
validating the data file; and
in response to successful validation, adding the plurality of domains to the data store, wherein the added domains are each associated with the one or more corresponding network addresses included in the data file.

12. The information handling system of claim 9 wherein the actions performed further comprise:
receiving a domain from the user;
receiving one or more network addresses corresponding to the received domain from the user;
adding the list of one or more network addresses to the data store, wherein the added network addresses are associated with the received domain.

13. The information handling system of claim 9 wherein the network address is received at a browser application running on the information handling system, wherein the browser application includes a reputation process that performs the receiving, retrieving, and connecting steps.

14. A computer program product stored in a computer readable medium, comprising computer instructions that, when executed by an information handling system, causes the information handling system to perform actions comprising:
receiving, from a domain name service (DNS) a network address based on a requested uniform resource locator (URL) that corresponds to a requested domain;
retrieving, from a data store accessible from the information handling system, a set of one or more network addresses previously established as corresponding to the requested domain; and
automatically connecting the information handling system to the network address in response to the received network address matching one of the set of one or more retrieved network addresses.

15. The computer program product of claim 14 wherein the actions performed further comprise:
prompting a user of the information handling system for a trust reply in response to the received network address failing to match one of the set of one or more retrieved network addresses;
receiving the trust reply from the user;
refraining from connecting the information handling system to the network address in response to the trust reply failing to indicate that the user trusts the received network address as corresponding to the requested domain; and
in response to the trust reply indicating that the user trusts the received network address as corresponding to the requested domain:
adding the received network address and the requested domain to the data store; and
connecting the information handling system to the network address.

16. The computer program product of claim 15 wherein the actions performed further comprise:
updating the data store, wherein the updating further comprises:
receiving, from a domain, a list of one or more network addresses pertaining to the domain;
validating the list; and
in response to successful validation, adding the list of one or more network addresses to the data store, wherein the added network addresses are associated with the domain.

17. The computer program product of claim 15 wherein the actions performed further comprise:
updating the data store, wherein the updating further comprises:
receiving, from service organization, a data file that includes a plurality of domains and a plurality of network addresses, wherein each of the domains correspond to one or more of the plurality of network addresses;
validating the data file; and
in response to successful validation, adding the plurality of domains to the data store, wherein the added domains are each associated with the one or more corresponding network addresses included in the data file.

18. The computer program product of claim 15 wherein the actions performed further comprise:
receiving a domain from the user;
receiving one or more network addresses corresponding to the received domain from the user;
adding the list of one or more network addresses to the data store, wherein the added network addresses are associated with the received domain.

19. The computer program product of claim 15 wherein the network address is received at a browser application running on the information handling system, wherein the browser application includes a reputation process that performs the receiving, retrieving, and connecting steps, and wherein the data store is stored on a nonvolatile storage device accessible to the information handling system.

20. The computer program product of claim 15 wherein the network address is received at a reputation process that performs the receiving, retrieving, and connecting steps on a proxy device accessible to a browser application via a local area network, and wherein the data store is stored on a nonvolatile network addressable storage device accessible to the information handling system via the local area network.
